(19) United States
(12) Patent Application Publication
(10) Pub. No.: US 2006/0144581 A1
(43) Pub. Date: Jul. 6, 2006

(54) Method for the regulation of an air-conditioning unit for a vehicle with closing chassis openings

(75) Inventor: Florian Kauf, Stuttgart (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 10/538,048

(22) PCT Filed: Oct. 25, 2003
(86) PCT No.: PCT/EP03/11864

§ 371 Date: Feb. 22, 2006

(30) Foreign Application Priority Data
Dec. 9, 2002 (DE) 102 57 587.8

(51) Int. Cl. B60H 3/00; B60H 1/00; B61D 27/00

(52) U.S. Cl. 165/202; 165/42

(57) ABSTRACT

A method for regulating an air conditioning system for a vehicle with closeable openings in the bodywork. It is sensed whether the openings in the bodywork, for example the convertible top of the vehicle is closed or opened. In the closed state, a regulating process of the air conditioning system which is customary for closed vehicles is carried out as a function of the parameters of ambient temperature, setpoint interior temperature, actual interior temperature and solar radiation. In the opened state, according to the invention the system is switched over to regulating the blowing out temperature and the air mass flow rate. The blowing out temperature and air mass flow rate are regulated as a function of the measured solar radiation, the ambient temperature and the speed of the vehicle. In this context, increases or reductions in the blowing out temperature and/or the air mass flow rate are carried out in order to obtain a relatively constant “interior temperature”. In order to increase comfort, a correction value can be additionally adjusted, it being possible to use said correction value to take into account, for example, the clothing and/or activity of the vehicle occupants.

This application claims priority to International Patent Application No. PCT/EP2003/011864, filed Oct. 25, 2003, designating the United States of America, and German Application DE 102 57 587.8, filed Dec. 9, 2002, the disclosures of which are expressly incorporated by reference herein.

### BACKGROUND AND SUMMARY OF THE INVENTION

The invention relates to a method for regulating an air conditioning system for a vehicle with closeable openings in the bodywork.

Current regulating concepts for air conditioning systems of open vehicles usually only take into account whether the convertible top is closed or opened.

German Patent document DE 38 43 898 C2 discloses a method for heating a vehicle in which a distinction is made between operation with the vehicle closed and operation with the vehicle opened. When the vehicle is closed, the heating system is controlled using the parameters of ambient temperature, setpoint interior temperature, actual interior temperature and, if appropriate, the speed of the vehicle. A regulating process is carried out only when there is a change in the interior temperature over time. When the vehicle is opened, a regulating process of the blowing out temperature is carried out, i.e. ambient conditions and the like are not taken into account.

German Patent document DE 195 44 893 C2 additionally discloses taking into account, as regulating parameters of an air conditioning solar radiation, namely its direction and intensity, which is sensed by a sensor for sensing the solar state.

It is not possible with the known methods for air conditioning to implement a regulating process which is adapted to the ambient temperatures and to the speed of the vehicle and therefore air conditioning which is comfortable in terms of temperature for the vehicle occupant or occupants. When a convertible top is opened the system is simply switched over to regulating the blowing out temperature and the speed of the vehicle and ambient conditions are not taken into account in this regulating process.

The object of the present invention is therefore to configure a method for regulating an air conditioning system for a vehicle with closeable openings in the bodywork, with which it is possible to achieve an air conditioning process adapted to the ambient conditions and the speed of the vehicle and comfortable in terms of temperature for the vehicle occupant or occupants, irrespective of the position of the convertible top.

These and further objects, advantages and features of the invention are apparent from the following description of a preferred exemplary embodiment of the invention in conjunction with the drawing.

### BRIEF DESCRIPTION OF THE DRAWING

FIGS. 1A and 1B show a flowchart of the air conditioning method according to the invention.

### DETAILED DESCRIPTION OF THE DRAWING

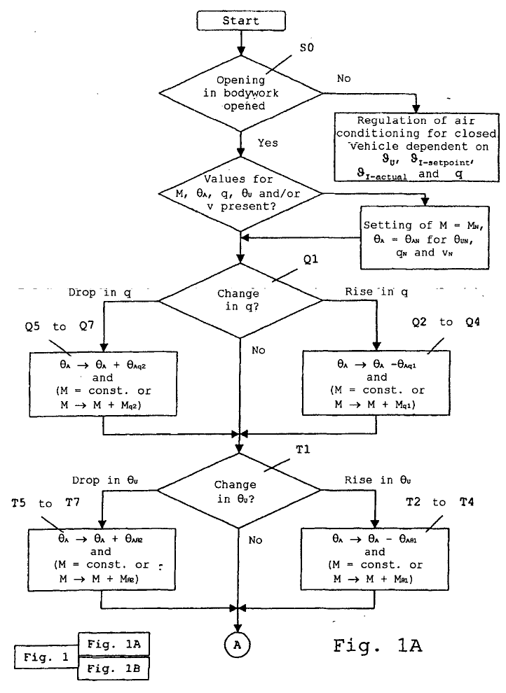

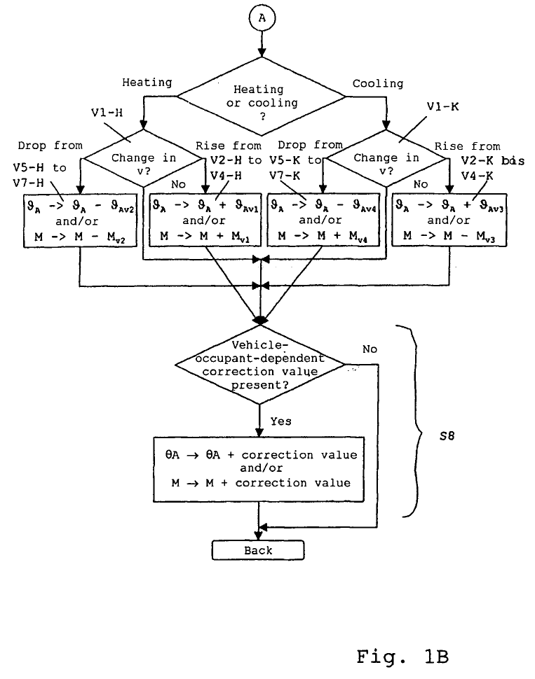

In the text which follows an air conditioning method according to the invention for a vehicle with closeable openings in the bodywork will be described in more detail with reference to FIGS. 1A and 1B, with which method a state which is comfortable in terms of temperature for the vehicle occupant or occupants can be brought about with the vehicle closed or opened.

In order to provide an air conditioning system which is comfortable in terms of temperature for the vehicle occupant or occupants irrespective of a position of a convertible top and of the speed of the vehicle, in the method according to the invention, in contrast to the prior art, various information is used as a regulating parameter when the convertible top is opened. When the convertible top is closed, the conventional, comfortable air conditioning is carried out. In contrast, when the convertible top is opened, in addition to the information about the ambient temperature, solar radiation (direction and intensity), setpoint interior temperature and actual interior temperature, which is conventionally used for air conditioning with a closed convertible top. In the method according to the invention the speed of the vehicle is also taken into account for regulating an air conditioning system for a vehicle with closeable openings in the bodywork since the speed of the vehicle has a significant influence on the comfort of the vehicle occupants in terms of the temperature. The speed of the vehicle is advantageously determined by means of the sensors which are otherwise used for regulating the vehicle dynamics in the vehicle. The sensors for sensing the solar radiation and the ambient temperature are already present from the conventional air conditioning system. For this reason, no additional sensors are necessary so that the method according to the invention improves comfort or reduces consumption in a cost-effective or cost-neutral way.

In the regulating process according to the invention, a state of an opening the bodywork is first sensed in step S0, i.e. it is determined whether the vehicle is closed or opened. If the vehicle is closed, a conventional air conditioning method is carried out taking into account the parameters of ambient temperature, setpoint interior temperature, actual interior temperature and solar radiation. However, in the case of an opened convertible top the method according to the invention which is described below with reference to FIGS. 1A and FIG. 1B is carried out in order to regulate an air conditioning system.

The regulating process according to the invention includes regulating sections which take into account the sensed parameters of solar radiation, ambient temperature and speed of the vehicle in the regulation of the blowing out temperature and of the mass flow. These regulating sections will be explained separately below and can either be implemented simultaneously or in chronological succession.

In the conventional blowing air regulating process, air is blown out with a constant, predefined air mass flow rate M_{N} and a blowing out temperature θ_{AN} which is determined in accordance with a preselected (by the user) setpoint temperature. In contrast, in the method according to the invention for air conditioning both the air mass flow rate and the blowing out temperature are regulated, and if there is a nozzle with a blowing direction which can also be regulated electrically, this is also regulated. The starting basis for the regulating process are the constant, predetermined air mass flow rate M_{N} and the blowing out temperature θ_{AN} predetermined in accordance with the preselected setpoint temperature, for each of which values a solar standard radiation value, a standard ambient temperature and a standard speed are predefined and these are used as comparison values if the solar radiation, the ambient temperature and/or the speed have not been measured until then.

Change in the Solar Radiation Δq

If a rise Δq in the solar radiation in comparison with a previously sensed solar radiation value is sensed (step Q1), the blowing out temperature θ_{A} is reduced by a value θ_{Aq1} and the air mass flow rate M is kept constant (step Q2). If this reduction in the blowing out temperature θ_{A} by the value θ_{Aq1} is not sufficient to compensate an increase in temperature by the rise Δq in the solar radiation (step Q3), to provide support, the air mass flow rate M is increased by a value M_{q1} (step Q4). In the case of heating it is alternatively also possible (not shown) for only the air mass flow rate M to be reduced by a value M_{q1′} and for the blowing out temperature θA to be kept constant.

If a drop −Δq in the solar radiation in comparison with a previously sensed solar radiation value is sensed (step Q1), the blowing out temperature θ_{A} is increased by a value θ_{Aq2} and the air mass flow rate M is kept constant (step Q5). If this increase in the blowing out temperature θ_{A} by the value θ_{Aq2} is not sufficient to compensate a reduction in temperature as a result of the drop −Δq in the solar radiation (step Q6), in order to provide support, the air mass flow rate M is increased by a value M_{q2} (step Q7). In the case of cooling it is alternatively possible (not shown) for only the air mass flow rate M to be reduced by the value M_{q2′} and for the blowing out temperature θ_{A} to be kept constant.

Change in the Ambient Temperature Δθ_{U}

If a rise Δθ_{U} in the ambient temperature in comparison with a previously sensed ambient temperature is sensed (step T1), the blowing out temperature θ_{A} is reduced by a value θ_{Aθ1} and the air mass flow rate M is kept constant (step T2). If this reduction in the blowing out temperature θ_{A} by the value θ_{Aθ1} is not sufficient to compensate an increase in temperature as a result of the rise AθU in the ambient temperature (step T3), in order to provide support, the air mass flow rate M is increased by a value M_{θ1} (step T4). In the case of heating it is alternatively possible (not shown) for only the air mass flow rate M also to be reduced by the value M_{θ1′} and for the blowing out temperature θ_{A} to be kept constant.

If a drop −Δθ_{U} in the ambient temperature in comparison with a previously sensed ambient temperature is sensed (step T1), the blowing out temperature θ_{A} is increased by a value θ_{Aθ2} and the air mass flow rate M is kept constant (step T5). If this increase in the blowing out temperature θ_{A} by the value θ_{Aθ2} is not sufficient to compensate a reduction in temperature as a result of the drop in the ambient temperature −Δθ_{U} (step T6), in order to provide support, the air mass flow rate M is increased by a value M_{θ2} (step T7) (case of heating). In the case of cooling it is also alternatively possible (not shown) for only the air mass flow rate M to be reduced by a value M_{θ2′} and for the blowing out temperature θ_{A} to be kept constant.

Change in the Speed Δv of the Vehicle

If there is a change in the speed Δv of the vehicle, a differentiation is made between a case of “heating” and a case of “cooling”. Whether a case of “heating” or “cooling” is occurring is dependent on the ambient temperature, on the sucked-in ambient temperature in the recirculation mode, on the solar radiation, the actual interior temperature and the setpoint interior temperature. “Heating”

If a rise Δv in the speed of the vehicle in comparison with a previously sensed speed is sensed (step V1-H), the blowing out temperature θ_{A} is increased by a value θ_{Av1} and the air mass flow rate M is kept constant (step V2-H). If this increase in the blowing out temperature Δ_{A} by the value Δ_{Av1} is not sufficient to compensate a reduction in temperature by the rise Δv in the speed of the vehicle (step V3-H), in order to provide support, the air mass flow rate M is increased by a value Mᵥ₁ (step V4-H). As an alternative to increasing the blowing out temperature θ_{A} by the value θ_{Av1} and keeping the air mass flow rate M constant it is also possible for only the air mass flow rate M to be increased by the value Mᵥ₁ and for the blowing out temperature θ_{A} to be kept constant.

If a drop −Δv in the speed of the vehicle in comparison with a previously sensed speed of the vehicle is sensed (step V1-H), the blowing out temperature θ_{A} is reduced by a value θ_{Av2} and the air mass flow rate M is kept constant (step V5-H). If this reduction in the blowing out temperature θ_{A} by the value θ_{Av2} is not sufficient to compensate an increase in temperature as a result of the drop in speed Δv of the vehicle (step V6-H), in order to provide support, the air mass flow rate M is reduced by a value Mᵥ₂ (step V7-H). As an alternative to reducing the blowing out temperature θ_{A} by the value θ_{Av2} and keeping the air mass flow rate M constant it is also possible only for the air mass flow rate M to be reduced by a value Mᵥ₂ and for the blowing out temperature θ_{A} to be kept constant.

“Cooling”

If a rise Δv in the speed of the vehicle in comparison with a previously sensed speed is sensed (step V1-K), the blowing out temperature θ_{A} is increased by a value θ_{Av3} and the air mass flow rate M is kept constant (step V2-K). If this increase in the blowing out temperature θ_{A} by the value θ_{Av3} is not sufficient to compensate a reduction in the temperature as a result of the rise Δv in the speed of the vehicle (step V3-K), in order to provide support, the air mass flow rate M is reduced by a value Mᵥ₃ (step V4-K). As an alternative to increasing the blowing out temperature θ_{A} by the value θ_{Av3} and keeping the air mass flow rate M constant it is also possible for only the air mass flow rate M to be reduced by the value Mᵥ₃ and for the blowing out temperature θ_{A} to be kept constant.

If a drop −Δv in the speed of the vehicle in comparison with a previously sensed speed of the vehicle is sensed (step V1-K), the blowing out temperature θ_{A} is reduced by a value θ_{Av4} and the air mass flow rate M is kept constant (step V5-K). If this reduction in the blowing out temperature θ_{A} by the value θ_{Av4} is not sufficient to compensate an increase in temperature as a result of the drop in the speed Δv of the vehicle (step V6-K), in order to provide support, the air mass flow rate M is increased by a value Mᵥ₄ (step V7-K). As an alternative to reducing the blowing out temperature θ_{A} by the value θ_{Av4} and keeping the air mass flow rate M constant it is also possible for only the air mass flow rate M to be increased by a value Mᵥ₄ and for the blowing out temperature θ_{A} to be kept constant.

A change value for the blowing out temperature and a change value for the air mass flow rate are subsequently formed from the values θ_{Aq1}, θ_{Aq2}, θ_{Aθ1}, θ_{Aθ2}, θ_{Av1} to θ_{Av4} and M_{q1}, M_{q2}, M_{θ1}, M_{θ2}, Mᵥ₁ to Mᵥ₄, with the values for the increase being added and the values for the reduction being subtracted. The regulating process of the air conditioning system is then carried out in accordance with the resulting optimized change values for the blowing out temperature and the air mass flow rate (step S8).

In addition to the above change values θ_{Aq1}, θ_{Aq2}, θ_{Aθ1}, θ_{Aθ2}, θ_{Av1}-θ_{Av4} and M_{q1}, M_{q2}, M_{θ1}, M_{θ2}, Mᵥ₁-Mᵥ₄, it is also possible to take into account a vehicle-occupant-dependent correction value which is, inter alia, also dependent on the degree of activity and/or clothing and is then combined additively or subtractively with the optimized blowing out temperature and the optimized air mass flow rate. This value can either be set manually or determined by adaptive operative control in response to subsequent adjustment by the user.

It is to be noted that in all the regulating situations at low speeds the air mass flow rate M tends to be reduced or kept constant owing to the resulting noise load and the adaptation is carried out by means of the temperature. It is thus also possible to reduce the air mass flow rate and bring about greater adaptation of the blowing out temperature instead of the keeping the air mass flow rate constant. Furthermore, it is to be noted that a change in the mass flow rate can take place more quickly than a change in the blowing out temperature.

The respective quantitative values θ_{Aq1}, θ_{Aq2}, θ_{Aθ1}, θ_{Aθ2}, θ_{Av1} to θ_{Av4} and M_{q1}, M_{q2}, M_{θ1}, M_{θ2}, M_{q1′}, M_{q2′}, M_{θ1′}, M_{θ2′}, Mᵥ₁ to Mᵥ₄ are vehicle-dependent. The associated profile curves can be determined by means of measurements on the vehicle.

In one preferred development of the air conditioning method according to the invention, upper and lower threshold values are additionally defined for the solar radiation q, the ambient temperature θ_{U} and v. For parameters values lying between these upper and lower threshold values, the profile curves mentioned above are accessed, i.e. an actual value for the regulating process is taken into account. Above the upper or below the lower threshold value, the upper or lower threshold value is used for the access to the profile curves since in these regions a regulating process can no longer be carried out or can no longer be perceived by the user to an extent which corresponds to the effort. For example, the limiting values for the radiation may be 200 W and 1000 W, the limiting values for the ambient temperature may be 5° C. and 30° C. and the limiting values for the speed may be 20 km/h and 80 km/h. However, this values are vehicle-dependent and may be significantly higher in very comfortable vehicles.

1. (canceled)

2. (canceled)

3. (canceled)

4. (canceled)

5. (canceled)

6. (canceled)

7. (canceled)

8. (canceled)

9. (canceled)

10. (canceled)

11. A method for regulating an air conditioning system for a vehicle with a convertible top which is able to be opened and closed, wherein a passenger compartment of the vehicle is supplied with a controllable temperature by means of an airstream which is fed via the air conditioning system, and the air conditioning system controls the temperature of the airstream when the convertible top is closed in such a way that a deviation of an actual interior temperature of the passenger compartment determined by means of an interior temperature sensor from a predefinable setpoint interior temperature assumes a minimum value, and a state of an opened convertible top is sensed by means of a switching device included in the air conditioning system, said method comprising the steps;
sensing an open or closed state of the convertible top,
providing an air conditioning regulating process using parameters of ambient temperature, setpoint interior temperature, actual interior temperature and solar radiation when a close state of said convertible tope is sensed,
sensing a solar radiation value and comparing with a previously sensed solar radiation value or the standard solar radiation value if a solar radiation value has not been sensed, when an open state of said convertible is sensed, and
if a rise in the solar radiation value is sensed during the comparison, reducing a blowing out temperature by a first value θ_{Aq1} and keeping an air mass flow rate constant or increasing the air mass flow rate by a first value M_{q1} if the change in the blowing out temperature alone is not enough to sufficiently lower the ambient temperature, wherein the blowing out temperature and the air mass flow rate and a blowing out direction have previously been determined as a function of the predefinable setpoint interior temperature, the determined actual interior temperature, ambient temperature and solar radiation,
if a drop in the solar radiation value is sensed during the comparison,
increasing the blowing out temperature by a second value θ_{Aq2} and keeping the air mass flow rate constant, or increasing the air mass flow rate is by a second value M_{q2} if the change in the blowing out temperature alone is not enough to sufficiently increase the ambient temperature,
sensing the ambient temperature and comparing the sensed ambient temperature with a previously sensed ambient temperature or the standard ambient temperature if an ambient temperature has not been sensed,
if a rise in the ambient temperature is sensed during the temperature comparison, the blowing out temperature is reduced by a first value θ_{Aθ1} and the air mass flow rate is kept constant,
increasing the air mass flow rate by a first value M_{θ1} if the change in the blowing out temperature alone is not enough to sufficiently reduce the ambient temperature,
if a drop in the ambient temperature is sensed during the comparison, increasing the blowing out temperature by a second value θ_{Aθ1} and keeping the air mass flow rate constant, or increasing the air mass flow rate by a second value M_{θ2} if the change in the blowing out temperature alone is not enough to sufficiently insure the ambient temperature,
determine whether a heating regulating process or a cooling regulating process is occurring, wherein,
in the heating regulating process, the speed of the vehicle is sensed and compared with a previously sensed speed of the vehicle or the standard speed of the vehicle if a speed of the vehicle has not yet been sensed, and if a rise in the speed of the vehicle is sensed during the comparison, at least one of the blowing out temperature is increased by a first value θ_{Av1} and the air mass flow rate is increased by a first value Mᵥ₁, and if a drop in the speed of the vehicle is sensed during the comparison, at least one of the blowing out temperature is reduced by a second value θ_{Av2} and the air mass flow rate is reduced by a second value Mᵥ₂, and wherein
in the cooling regulating process, the speed of the vehicle is sensed and compared with a previously sensed speed of the vehicle or the standard speed of the vehicle if a speed of the vehicle has not yet been sensed, and if a rise in the speed of the vehicle is sensed during the comparison, at least one of the blowing out temperature is increased by a third value θ_{Av3} and the air mass flow rate is reduced by a third value M_{v3,} and if a drop in the speed of the vehicle is sensed during the comparison, at least one of the blowing out temperature is reduced by a fourth value Δ_{Av4} and the air mass flow rate is increased by a fourth value M_{v4.}

12. The method for regulating an air conditioning system as claimed in claim 11, wherein, if an opened state of the convertible top has been sensed and at least one of a blowing out temperature and air mass flow rate has not been determined by the method, a constant predefined air mass flow rate M_{N} and a blowing out temperature θ_{AN} which is predetermined in accordance with a preselected setpoint temperature are used as first values for each of which a standard solar radiation value, a standard ambient temperature and a standard speed are predefined.

13. The method for regulating an air conditioning system as claimed in claim 11, wherein the step of determining whether a heating regulating process or a cooling process is occurring already takes place at the start of the method and
if it is determined that a heating regulating process is occurring, at least one of the air mass flow rate is reduced by a value M_{q1′} and the blowing out temperature θ_{A} is kept constant by having the first value θ_{Aq1} at substantially zero, and the air mass flow rate is reduced by a value M_{θ1} and the blowing out temperature θ_{A} is kept constant, and
if it is determined that a cooling regulating process is occurring, at least one of the air mass flow rate is reduced by a value M_{q2′} and the blowing out temperature θ_{A} is kept constant by having the second value θ_{Aq2} at substantially zero, and the air mass flow rate is reduced by a value M_{θ2} and the blowing out temperature θ_{A} is kept constant.

14. The method for regulating an air conditioning system as claimed in claim 12, wherein the step of determining whether a heating regulating process or a cooling process is occurring already takes place at the start of the sequence and
if it is determined that a heating regulating process is occurring, at least one of the air mass flow rate is reduced by a value M_{q1′} and the blowing out temperature θ_{A} is kept constant, and the air mass flow rate is reduced by a value M_{θ1} and the blowing out temperature θ_{A} is kept constant, and
if it is determined that a cooling regulating process is occurring, at least one of the air mass flow rate is reduced by a value M_{q2′} and the blowing out temperature θ_{A} is kept constant, and the air mass flow rate is reduced by a value M_{θ2} and the blowing out temperature θ_{A} is kept constant.

15. The method for regulating an air conditioning system as claimed in claim 11, further comprising the step of forming a change value for the blowing out temperature and a change value for the air mass flow rate from the values θ_{Aq1}, θ_{Aq2}, θ_{Aθ1}, θ_{Aθ2}, θ_{Av1}-θ_{Av4} and M_{q1}, M_{q2}, M_{θ1}, M_{θ2}, Mᵥ₁-Mᵥ₄, with the values for the increase being added and the values for the reduction being subtracted and the blowing out temperature and the air mass flow rate being regulated in accordance with the change value which is obtained for the blowing out temperature and the change value which is obtained for the air mass flow rate.

16. The method for regulating an air conditioning system as claimed in claim 12, further comprising the step forming a change value for the blowing out temperature and a change value for the air mass flow rate from the values θ_{Aq1}, θ_{Aq2}, θ_{Aθ1}, θ_{Aθ2}, θ_{Av1}-θ_{Av4} and M_{q1}, M_{q2}, M_{θ1}, M_{θ2}, Mᵥ₁-Mᵥ₄, with the values for the increase being added and the values for the reduction being subtracted and the blowing out temperature and the air mass flow rate being regulated in accordance with the change value which is obtained for the blowing out temperature and the change value which is obtained for the air mass flow rate.

17. The method for regulating an air conditioning system as claimed in claim 13, further comprising the step of forming a change value for the blowing out temperature and a change value for the air mass flow rate from θ_{Aq1}, θ_{Aq2}, θ_{Aθ1}, θ_{Aθ2}, θ_{Av1}-θ_{Av4} and M_{q1}, M_{q2}, M_{θ1}, M_{θ2}, Mᵥ₁-Mᵥ₄, with the values for the increase being added and the values for the reduction being subtracted and the blowing out temperature and the air mass flow rate being regulated in accordance with the change value which is obtained for the blowing out temperature and the change value which is obtained for the air mass flow rate.

18. The method for regulating an air conditioning system as claimed in claim 14, further comprising the steps of forming a change value for the blowing out temperature and a change value for the air mass flow rate from the values θ_{Aq1}, θ_{Aq2}, θ_{Aθ1}, θ_{Aθ2}, θ_{Av1}-θ_{Av4} and M_{q1}, M_{q2}, M_{θ1}, M_{θ2}, Mᵥ₁-Mᵥ₄, with the values for the increase being added and the values for the reduction being subtracted and the blowing out temperature and the air mass flow rate being regulated in accordance with the change value which is obtained for the blowing out temperature and the change value which is obtained for the air mass flow rate.

19. The method for regulating an air conditioning system as claimed in claim 15, wherein in the forming step a vehicle-occupant-dependent, adjustable correction value is also taken into account in the formation of the change value for the blowing out temperature and the change value for the air mass flow rate, which correction value can contribute to the change values in an additive or subtractive fashion.

20. The method for regulating an air conditioning system as claimed in claim 16, wherein in the forming step a vehicle-occupant-dependent, adjustable correction value is also taken into account in the formation of the change value for the blowing out temperature and the change value for the air mass flow rate, which correction value can contribute to the change values in an additive or subtractive fashion.

21. The method for regulating an air conditioning system as claimed in claim 17, wherein in the forming step a vehicle-occupant-dependent, adjustable correction value is also taken into account in the formation of the change value for the blowing out temperature and the change value for the air mass flow rate, which correction value can contribute to the change values in an additive or subtractive fashion.

22. The method for regulating an air conditioning system as claimed in claim 18, wherein in the forming step a vehicle-occupant-dependent, adjustable correction value is also taken into account in the formation of the change value for the blowing out temperature and the change value for the air mass flow rate, which correction value can contribute to the change values in an additive or subtractive fashion.

23. The method for regulating an air conditioning system as claimed in claim 19, wherein the correction value is one of adjusted manually and defined by adaptive operator control in response to subsequent adjustment by the user.

24. The method for regulating an air conditioning system as claimed in claim 20, wherein the correction value is one of adjusted manually and defined by adaptive operator control in response to subsequent adjustment by the user.

25. The method for regulating an air conditioning system as claimed in claim 21, wherein the correction value is one of adjusted manually and defined by adaptive operator control in response to subsequent adjustment by the user.

26. The method for regulating an air conditioning system as claimed in claim 22, wherein the correction value is one of adjusted manually and defined by adaptive operator control in response to subsequent adjustment by the user.

27. The method for regulating an air conditioning system as claimed in claim 11, wherein the values θ_{Aq1}, θ_{Aq2}, θ_{Aθ1}, θ_{Aθ2}, θ_{Av1}-θ_{Av4} and M_{q1}, M_{q2}, M_{θ1}, M_{θ2}, Mᵥ₁-Mᵥ₄ are vehicle-dependent and are obtained from profile curves determined by measurements on the vehicle.

28. The method for regulating an air conditioning system as claimed in claim 27, wherein the profile curves are used only between predefined lower and upper threshold values for the solar radiation, ambient temperature and the speed of the vehicle, and for values below the lower threshold value the change value which is assigned to the lower threshold value is always used, and for values above the upper threshold value the change value which is assigned to the upper threshold value is always used.

29. The method for regulating an air conditioning system as claimed in claim 28, wherein 200 W and 1000 W are used as threshold values for the solar radiation, 5° C. and 30° C. are used as threshold values for the ambient temperature, and 20 km/h and 80 km/h are used as threshold values for the speed of the vehicle.

30. The method for regulating an air conditioning system as claimed in claim 11, wherein the steps of sensing a solar radiation value, reducing a blowing out temperature, and increasing the air mass flow rate are carried out either in chronological succession or simultaneously, wherein the steps of sensing the solar radiation value, increasing the blowing out temperature by second value and increasing the air mass flow rate are carried out either in chronological succession or simultaneously or the steps of sensing the ambient temperature, reducing the blowing out temperature and increasing the air mass flow rate are carried out either in chronological succession or simultaneously and wherein the steps of sensing the ambient temperature, increasing the blowing out temperature and increasing the air mass flow rate by second value are either carried out in chronological succession or simultaneously and wherein the steps of sensing the speed of the vehicle, increasing the blowing out temperature or the air mass flow rate are carried out either in chronological succession or simultaneously and wherein the steps of sensing the speed of the vehicle and either reducing the blowing out temperature or reducing the air flow mass are carried out either in chronological succession or simultaneously and wherein the steps of reducing the blowing out temperature or increasing the air flow mass are carried either in chronological succession or simultaneously.
